(19) United States
(12) Patent Application Publication
(10) Pub. No.: US 2010/0031472 A1
(43) Pub. Date: Feb. 11, 2010

(54) HINGE

(75) Inventor: Jung-Bin Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,417

(22) Filed: Dec. 9, 2008

(30) Foreign Application Priority Data
Aug. 7, 2008 (CN) 200820301784.1

(51) Int. Cl. E05D 11/10; E05D 7/00

(52) U.S. Cl. 16/297; 16/348

(57) ABSTRACT

A hinge includes a shaft, a bracket, and a first interfering member. The shaft includes a post, with a noncircular cross section. The bracket defines a pivoting hole for the post of the shaft extending therethrough. The first interfering member defines a noncircular through hole for the post of the shaft extending therethrough. The first interfering member forms a wedge extending into the through hole for engaging with the post.

### CROSS-REFERENCE TO RELATED APPLICATIONS

Relevant subject matter is disclosed in co-pending U.S. patent applications (Application No. 12/205931, Attorney Docket No. US20946, filed on Sep. 8, 2008 and entitled “HINGE AND INTERFERENCE APPARATUS FOR THE SAME;” application Ser. No. 12/202331, Attorney Docket No. US20987, filed on Sep. 1, 2008 and entitled “HINGE AND INTERFERENCE APPARATUS FOR THE SAME;” Attorney Docket No. US22915, entitled “HINGE”), which are assigned to the same assignee as this patent application. The disclosure of the co-pending applications is incorporated herein by reference.

### BACKGROUND

1. Technical Field

The disclosure relates to mechanical structures, and particularly to a hinge.

2. Description of Related Art

A collapsible device, such as a notebook computer or a clamshell mobile phone, generally includes two parts pivotally connected via a hinge. The hinge generally includes a bracket mounted to one part of the collapsible device and a shaft with one end mounted to the other part of the collapsible device.

An interfering member of the hinge usually defines a noncircular through hole for the shaft extending therethrough. However, the through hole of the first interfering member is usually not exact and greater than the ideal size to make the first interfering member be loosely fitting about the shaft, which makes the shaft hit the sidewall bounding the through hole of the first interfering member while rotating the shaft, resulting in noises.

Therefore, the present disclosure provides a hinge to obviate the described limitations.

### BRIEF DESCRIPTION OF THE DRAWINGS

FIG. 1 is an assembled isometric view of an exemplary embodiment of a hinge.

FIGS. 2 and 3 are exploded isometric views of the hinge of FIG. 1, but viewed from two different perspectives, the hinge including a first interfering member.

FIG. 4 is an enlarged view of the first interfering member of FIG. 3.

### DETAILED DESCRIPTION

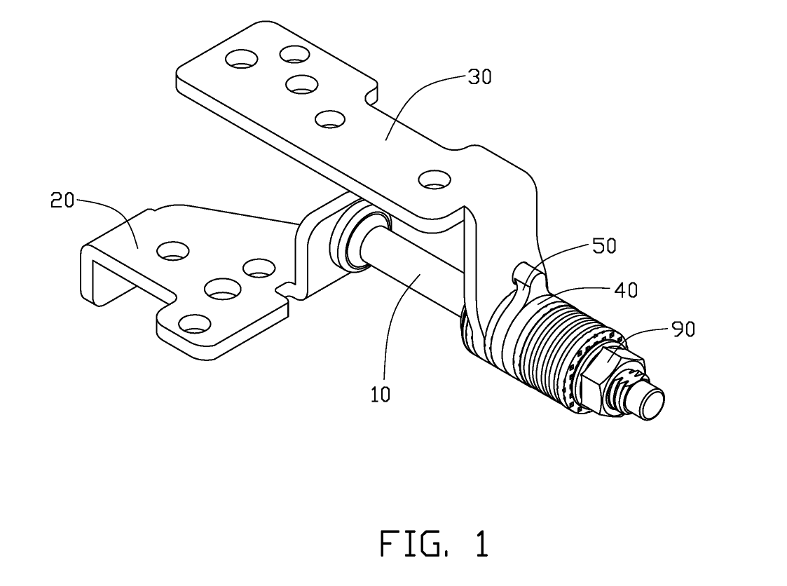

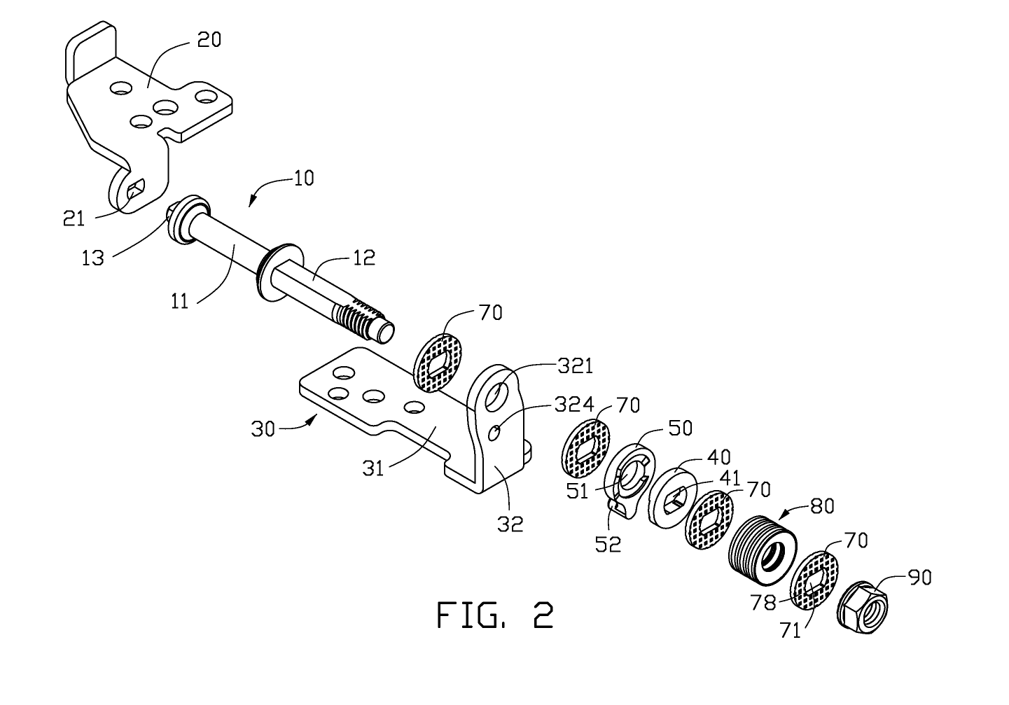

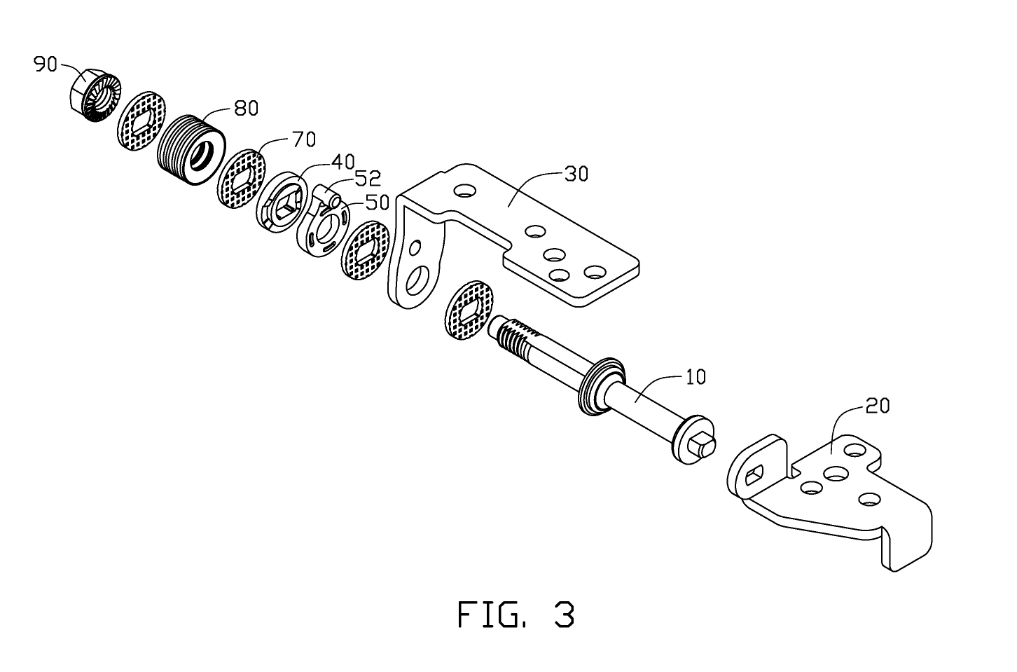

Referring to FIGS. 1 to 3, an exemplary embodiment of a hinge is adapted to be mounted to a collapsible device, such as a notebook or a clamshell mobile phone, includes two parts rotatably connected to each other via the hinge. The hinge includes a shaft 10, a rack 20, a bracket 30, a first interfering member 40, a second interfering member 50 engagably with and rotatably relative to the first interfering member 40, a plurality of washers 70, a resilient assembly 80, and a fastener 90.

The shaft 10 includes a generally cylindrical pole 11, with a post 12 and an engaging portion 13 protruding from opposite ends of the pole 11. The post 12 has a noncircular, such as double-D shaped, cross section. A distal end away from the pole 11 of the post 12 forms a threaded portion. A cross section of the engaging portion 13 is noncircular to fix the shaft 10 to the rack 20. In other embodiments, the cross section of the engaging portion 13 may be any other shape that also enables the shaft 10 to be fixed to the rack 20.

The rack 20 includes a main body and a flange perpendicularly connected to an end of the main body. The flange defines a noncircular-shaped engaging hole 21 corresponding to the engaging portion 13. A plurality of securing holes are defined in the main body, for mounting the rack 20 to one part of the collapsible device.

The bracket 30 includes a main body 31 and a flange 32 perpendicularly extending from an end of the main body 31. The main body 31 defines a plurality of securing holes therein, for mounting the bracket 30 to the other part of the collapsible device. The flange 32 defines a round pivoting hole 321, for rotatably receiving the post 12 of the shaft 10. The flange 32 also defines a positioning hole 324 adjacent to the pivoting hole 321.

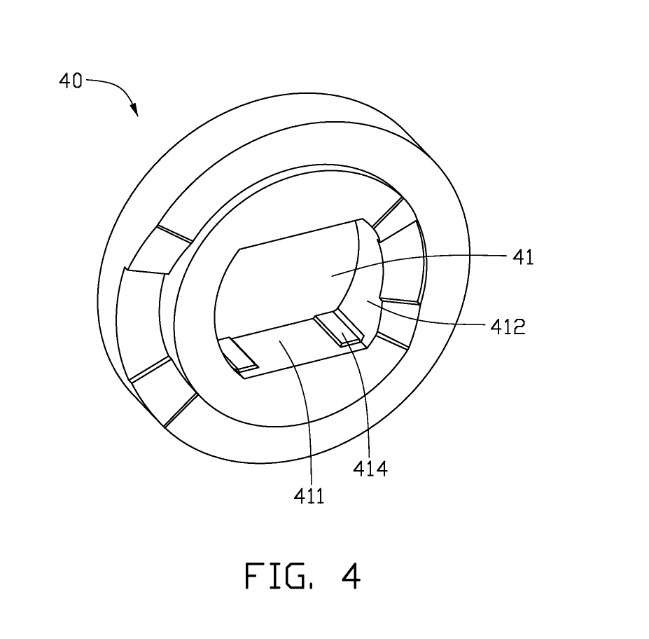

Referring to FIG. 4, the first interfering member 40 defines a double-D shaped through hole 41, corresponding to the post 12 of the shaft 10, to snugly fit about the post 12. The first interfering member 40 forms two opposite planar sidewalls 411 and two opposite arc-shaped sidewalls 412 to bound the through hole 41. Each planar sidewall 411 includes two wedges 414 protruding therefrom, adjacent to the corresponding arc-shaped sidewalls 412, for firmly engaging with the post 12 of the shaft 10. A side of the first interfering member 40 facing the second interfering member 50 forms a plurality of depressed portions or a plurality of protruded portions. In alternative embodiments, the wedges 414 may extend from the arc-shaped sidewalls 412 for firmly engaging with the post 12 of the shaft 10.

The second interfering member 50 defines a round through hole 51, for rotatably receiving the post 12. A side of the second interfering member 50 facing the first interfering member 40 forms a plurality of protruded portions or a plurality of depressed portions, to engage with the depressed portions or protruded portions of the first interfering member 40. An inserting portion 52 is formed on a circumference of the second interfering member 50, for being inserted into the positioning hole 324 to fix the second interfering member 50 to the bracket 30.

Each washer 70 defines a double-D shaped through hole 71, to snugly fit about the post 12. Opposite sides of the washer 70 define a plurality of receiving holes 78, for retaining lubricant.

In one embodiment, the resilient assembly 80 includes a plurality of resilient frictional washers. These washers are stacked together, and rotationally retained around the post 12. In alternative embodiments, the resilient assembly 80 can be a spring or other resilient component. In one embodiment, the fastener 90 is a hexagonal nut, and can be screwed to the threaded portion of the post 12.

Referring to FIGS. 1 to 4, in assembly, the engaging portion 13 of the shaft 10 is inserted into the engaging hole 21 of the rack 20. The post 12 of the shaft 10 is inserted through the through hole 71 of a first washer 70, the pivoting hole 321 of the bracket 30, the through hole 71 of a second washer 70, the through hole 51 of the second interfering member 50, the through hole 41 of the first interfering member 40, the through hole 71 of a third washer 70, the resilient assembly 80, and the through hole 71 of a fourth washer 70 in that order, then is screwed to the fastener 90. The inserting portion 52 of the second interfering member 50 is inserted into the positioning hole 324 of the bracket 30.

The post 12 of the shaft 10 rotates in the pivoting hole 321 of the bracket 30. The wedges 414 are used for engaging with the post 12 of the shaft 10 to firmly mount the first interfering member 40 to the post 12 of the shaft 10. The wedges 414 decreases clearance between the through hole 41 and the post 12 of the shaft 10, to avoid the post 12 hitting the planar sidewall 411 of the first interfering member 40 for preventing noise during rotation.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a shaft comprising a post, the post having a noncircular cross section;
a bracket defining a pivoting hole for the post of the shaft extending therethrough; and
a first interfering member defining a noncircular through hole for the post of the shaft extending therethrough, the first interfering member forming a wedge extending into the through hole for engaging with the post.

2. The hinge of claim 1, further comprising a second interfering member engaging with the first interfering member, the second interfering member is mounted to the bracket, the post is rotatably inserted through the second interfering member.

3. The hinge of claim 2, further comprising a resilient assembly and a fastener, wherein the resilient assembly is rotatably retained around the post, the fastener is fixed to the distal end of the post to limit the second interfering member, the first interfering member, and the resilient assembly on the post, and the resilient assembly is located between the first interfering member and the fastener.

4. The hinge of claim 3, wherein the resilient assembly includes a plurality of resilient frictional washers, the plurality of frictional washers being stacked together and rotationally retained around the post.

5. The hinge of claim 3, further comprising a washer located between the resilient assembly and the fastener, wherein the washer defines a noncircular through hole to snugly fit about the post, and opposite sides of the washer define a plurality of receiving holes for retaining lubricant.

6. The hinge of claim 2, wherein the bracket defines a positioning hole, the second interfering member forms an inserting portion inserted into the positioning hole to fix the second interfering member to the bracket.

7. The hinge of claim 2, further comprising a washer located between the second interfering member and the bracket.

8. The hinge of claim 7, wherein the washer defines a noncircular through hole to snugly fit about the post.

9. The hinge of claim 1, wherein the first interfering member forms two opposite planar sidewalls and two opposite arc-shaped sidewalls to bound the through hole, the wedge protrudes on one of the two opposite planar sidewalls.

10. The hinge of claim 9, wherein the wedge further protrudes on one of the two opposite arc-shaped sidewalls.

11. A hinge, comprising:
a rack with a shaft fixed thereto, the shaft comprising a post, the post having a noncircular cross section;
a bracket defining a pivoting hole for rotatably receiving the post therein;
a first interfering member defining a through hole to fit about the post, and forming a plurality of wedges extending into the through hole for engaging with the post; and
a second interfering member mounted to the bracket, the second interfering member engaging with the first interfering member to optimize the rotation of the post of the shaft in the pivoting hole of the bracket.

12. The hinge of claim 11, further comprising a resilient assembly and a fastener, wherein the resilient assembly is rotatably retained around the post, the fastener is fixed to a distal end of the post to limit the first interfering member and the resilient assembly on the post, and the resilient assembly is located between the first interfering member and the fastener.

13. The hinge of claim 12, wherein the resilient assembly includes a plurality of resilient frictional washers, the plurality of frictional washers being stacked together and rotationally retained around the post.

14. The hinge of claim 11, wherein the bracket defines a positioning hole, the second interfering member forms an inserting portion inserted into the positioning hole to fix the second interfering member to the bracket.

15. The hinge of claim 11, wherein the second interfering member defines a round through hole, the post is rotatably inserted through the through hole of the second interfering member.

16. The hinge of claim 11, wherein the first interfering member forms two opposite planar sidewalls and two opposite arc-shaped sidewalls to bound the through hole, the plurality of wedges protrude on the opposite planar sidewalls.

17. The hinge of claim 16, wherein the wedge further protrudes on one of the two opposite arc-shaped sidewalls.
